(19) United States
(12) Patent Application Publication
(10) Pub. No.: US 2026/0322052 A1
(43) Pub. Date: Oct. 15, 2026

(54) IMPROVED ELECTRICAL INTERFACES FOR MOTORS

(71) Applicant: TETHR LIMITED, N.T. Tsuen Wan, Hong Kong (CN)

(72) Inventors: Nikola Tomislav V NIKOLICH, London (GB); Jensen LAI, Madison, CT (US)

(21) Appl. No.: 19/106,915

(22) PCT Filed: Aug. 31, 2023
(86) PCT No.: PCT/CN2023/116370

§ 371 Date: Feb. 26, 2025

(30) Foreign Application Priority Data
Aug. 31, 2022 (GB) 2212611.4

(51) Int. Cl. H01R 39/28; H01R 39/12; H01R 39/20; H01R 43/10; H02K 13/00

(52) U.S. Cl. CPC H01R 39/28; H01R 39/12; H01R 39/20; H01R 43/10; H02K 13/003; H01R 2201/10

(57) ABSTRACT

This disclosure relates to an electrical interface, electric motor, linear electric motor, and method of manufacturing an electrical interface. There is provided an electrical interface comprising a first portion with a first conductive surface, a second portion with a second conductive surface, and at least one flexible conductive band configured to transmit electrical power between the first and second conductive surfaces, wherein the second portion is configured to move relative to the first portion, wherein the at least one flexible conductive band is positioned between the first conductive surface and the second conductive surface, wherein the at least one flexible conductive band is configured to maintain constant electrical contact between the first conductive surface and the second conductive surface when the second portion is moved relative to the first portion.

### TECHNICAL FIELD

This invention relates to an electric interface with is suitable for use in electric motors and in particular to arrangements for effecting an electrical connection between the two relatively movable components of such motors.

It is also considered that the present invention can be used as an electrical interface for non-motor applications, in any case where electrical power needs to be transferred from a stationary object to a moving (e.g., rotating) object.

### BACKGROUND

In There are two well-known types of rotating electric motor. In the first type, an electrical power source is connected by means of brushes to coils on an armature which is arranged for rotation about, or within, a stator in the form of one or more permanent magnets. The rotation of the armature relative to the brushes also serves to switch the electric current between the coils. In the second type, the rotor comprises a plurality of permanent magnets, and the stator comprises the coils and the associated electrical circuitry which controls the switching of the electrical power source between the coils.

A problem with the first type is that the use of brushes to connect the power supply to the rotating armature inevitably gives rise to some degree of arcing, and the associated undesirable consequences of wear of the brushes, electromagnetic, typically radiofrequency, interference and audible noise.

The problems associated with brushes do not arise in the second type of motor. However, the rotating magnets of the second type of motor have to be structured so as to withstand the substantial inertial stresses typically encountered in high-speed motors.

Linear motors, such as non-commutated linear actuators, are also known. The noncommutated linear actuator (also referred to as a voice coil linear actuator, or a noncommutated DC linear actuator, when a DC signal is applied) is a direct drive linear actuator. It consists of a permanent magnetic field assembly and a coil assembly, and is arranged such that the current flowing through the coil assembly interacts with the permanent magnetic field generated by the permanent magnetic field assembly so as to generate a force vector perpendicular to the direction of the current.

Typical non-commutated linear actuators suffer from a number of drawbacks. Firstly, because the interaction between the current flowing in the coil assembly and the permanent magnetic field can result in varying forces when the movable component in the actuator is at different positions along the length of movement. This requires an increased complexity in motor control so as to compensate for these differences in force. Furthermore, as these devices rely on an alignment of a movable component that translates relative to a stationary component, the alignment between the movable component and the stationary component is critical to achieve the desired forces. Typical non-commutated linear actuators, however, suffer from poor protection from external forces, such as a mechanical shock, leading to misalignment between the stationary and movable components. Finally, when the coil assembly of the non-commutated linear actuator is part of the movable component in the actuator, there is a further issue with reliability regarding the electrical connection to this coil assembly. For example, where wires are used to connect to the coil assembly, regular movement of the movable component can lead to quick wear on the wires, resulting in failure of the motor.

It would therefore be desirable to provide arrangements for overcoming, or at least mitigating, the problems of conventional electric motors.

### SUMMARY

In accordance with a first aspect of the present invention there is provided an electrical interface comprising a first portion with a first conductive surface, a second portion with a second conductive surface, and at least one flexible conductive band configured to transmit electrical power between the first and second conductive surfaces. The second portion is configured to move relative to the first portion. The at least one flexible conductive band is positioned between the first conductive surface and the second conductive surface. Finally, the at least one flexible conductive band is configured to maintain constant electrical contact between the first conductive surface and the second conductive surface when the second portion is moved relative to the first portion.

By providing an electrical interface with a flexible conductive band instead of a brushed arrangement for a rotary motor, the advantages of the prior-art rotary motors are achieved without the need for the provision of brushes, and the problems specific to prior-art motors of the second type do not arise. The electrical interface also reduces the wear and stress experienced by the linear actuator, because there is no joint between wires and a movable component of the linear actuator.

It is to be understood that a “flexible conductive band” may refer to a strip, or loop, of material. The band itself may be at least partially formed out of a conductive material, or there may be conductive elements positioned on, around, or connected to a non-conductive substrate of the band. It may be also understood that “flexible” refers to a capacity for the conductive band to bend or deform without breaking.

In some embodiments, the flexible conductive band is an elastic element that can be deformed (e.g., compressed) from a resting state to an assembled state, when positioned between the first and second conductive surfaces. The flexible conductive band in such an assembled state can be under a mechanical strain, whereby the flexible conductive band is being urged back to its resting state. Such a property can allow for improved electrical connection between the first and second conductive portions, as the surface area of electrical contact is maximised.

In some embodiments, the at least one flexible conductive band is configured to interact mechanically with the first portion at a first contact area and interact mechanically with the second portion at a second contact area, such that when the second portion is moved relative to the first portion the flexible conductive band is configured to travel in a predefined path along the first conductive surface.

In some embodiments, to travel in the predefined path, the at least one flexible conductive band is configured to move in a rolling motion.

It is to be understood that a portion moving “relative” to another portion describes both rotary motion (whereby the first portion is rotating relative to the second portion, or vice versa) and translating, or linear, motion (whereby the first portion is moving in a linear direction relative to the second portion).

It is also to be understood that a “rolling motion” refers to a motion where the flexible conductive band is revolving around a central axis of the flexible conductive band (similar to the revolving motion experienced by other “bands”, such as a wheel of a vehicle or a belt on a treadmill), and also where the central axis is being translated in a first direction (so as to permit a rolling movement). An example of this rolling motion can be seen on continuous tracks used in vehicle propulsion.

In some embodiments, the first portion comprises a first insulating body, the second portion comprises a second insulating body, the first conductive surface is mounted on the first insulating body, and the second conductive surface is mounted on the second insulating body.

In some embodiments, the first conductive surface is positioned within a track in the first insulating body, and wherein the second conductive surface is positioned within a track in the second insulating body.

Insulating bodies can be present on the first portion and second portion so as to provide isolation between the electrical current path on the respective portion and the surrounding electronics and the remainder of the first and second portion (which may include further conductive pathways which need to remain isolated so as to avoid shorting risks). When the electric interface is incorporated as part of a broader electrical component, the insulating bodies are also important for isolating the conductive surfaces from adjacent components (such as metallic chassis of motors, which are grounded for safety).

It may be understood that a “track” refers to a groove, or a channel, in the insulating body. It therefore can be considered to refer to an arrangement whereby a conductive surface is surrounded on at least one side by a wall of insulating material.

In some embodiments, the first insulating body, the second insulating body, or both of the first and second insulating bodies comprise at least one projection, and the at least one conductive band comprises at least one notch configured to interact with the at least one projection as the flexible conductive band travels along the predefined path.

In some embodiments, wherein the first insulating body, the second insulating body, or both of the first and second insulating bodies comprise a plurality of projections, and wherein the at least one conductive band comprises a plurality of notches configured to interact with the plurality of projections as the at least one flexible conductive band travels along the predefined path.

A projection may refer to a feature which extends beyond a surface of the insulating body into the predefined path in which the flexible conductive band travels. Where a conductive surface is positioned within a track of the respective insulating body, the projection may extend into the track. A notch may refer to a removal of material in the flexible conductive band. It is to be understood that the notch can refer to such a removal of material along at least one of the edges of the flexible conductive band (e.g. one or more notches can be formed in the side edge of a strip of material, and then then a top and bottom edge of the strip can be connected together to form the band, resulting in a flexible conductive band with at least one notch formed in an edge).

Both the projection(s) and the notch(es) can take any shape, so long as the shape of the projection fits within the notch so as to couple the respective insulating body to the flexible conductive band and improve the mechanical interaction between the insulating body and the flexible conductive band. One benefit of having at least one projection on the insulating body and at least one notch on the flexible conductive band is that any slip between the first portion and the second portion is reduced. In other words, because a projection in the insulating body is configured to interact with a corresponding notch in the flexible conductive band, the flexible conductive band can be more easily pulled into a rolling motion when the first portion moves relative to the second portion. This can result in an improved electrical connection between the first portion and the second portion, and can also reduce the amount of friction present between the flexible conductive band and each of the first and second portions.

It is also important to minimize slippage between the flexible conductive band and the first and second portion so as to improve electric performance. This is because, in operation, current can flow across the electrical interface. The current can enter the flexible conductive band along a plane of contact (i.e., a plane formed between the first portion and the flexible conductive band). Likewise, the current will leave the flexible conductive band along a second plane of contact (i.e., a plane formed between the second portion and the flexible conductive band). Because of these planes of contact, it is possible that non-uniform current flow along the planes of contact could arise, resulting in current constriction (also known as current crowding).

Without the projections/notches being present, the likelihood of slippage between the flexible conductive band and the first/second portion will increase, resulting in an increase in friction and an increase in current constriction (leading to further power losses and risk of damage due to undesirable and uneven heating of the componentry).

This non-uniform current flow can therefore be mitigated by limiting the amount of slippage between the components. This effect is particularly advantageous when the electrical interface is implemented within higher power (>1 kW) motors.

Furthermore, in instances where multiple, flexible conductive bands are present within the same predetermined path (i.e., within the same track of the insulating body and contacting the same conductive surfaces), the at least one projection and the at least one notch are advantageous for ensuring appropriate spacing between the multiple, flexible conductive bands. That is, were two flexible conductive bands travelling in a rolling motion along the same conductive surface to come into contact with one another, this may result in worse performance due to the additional friction introduced into the interface. The projection(s) and notch(es) addresses this problem, by ensuring adequate spacing between bands when multiple bands are present.

Whilst these above advantages will arise with only a single projection and notch, the effect is strengthened with a plurality of projections and corresponding notches. When a plurality of these components are present, the projections may be evenly dispersed (i.e. have a uniform width between the projections) along the length of the predefined path. The notches may also be evenly dispersed along the circumference of the respective flexible conductive band, with the same uniform width as those of the projections.

The projections and notches can be disposed at any suitable place along the insulating body/flexible conductive band. For example, only one edge of the flexible conductive band can include notches. Alternatively, both edges of the flexible conductive band can include notches. In such an embodiment, ease in manufacturing can be improved, as it would not be necessary to ensure that the band was appropriately orientated with the insulating body (if the projections were only present along one edge of the insulating body).

In some embodiments, the at least one flexible conductive band comprises a plurality of flexible conductive bands.

One advantage to the presence of multiple, flexible conductive bands is an increase in the maximum electrical power which can be transmitted from the first portion to the second portion. When the electrical interface is implemented within a motor, this can result in an improved maximum torque available during operation.

In some embodiments, the at least one flexible conductive band comprises a flexible polymeric substrate with a conductive coating, optionally wherein the flexible polymeric substrate comprises polyimide.

One benefit of a flexible polymeric substrate, such as a polyimide plastic film, is the ability for this material to withstand many flexing and bending cycles without failure. The polyimide film can also be coated with a multitude of highly electrically conductive coatings and finishes (e.g., one conductive coating can comprise graphene). As a finish, the substrate can be electroless-plated or electroplated by ion deposition in solution. Alternative conductive coatings can comprise metals like copper (applied via, e.g., electro-deposition in a copper chloride or copper sulphate solution), nickel, palladium, ruthenium, or other appropriate metal. The multiple plating and coating onto flexible plastic substrates is advantageous for small motors that are mass-produced, in particular in reducing the cost associated with manufacturing. This is because such a flexible conductive band can further reduce the dependency of costly metals that are in use today for such motors.

In some instances, the polymeric substrate (also referred to herein as a carrier substrate) can be surface treated to increase the “seeding” of an electroless metal. The substrate can then be placed into a bath of a solution of such an electroless metal (e.g., electroless copper or nickel) until the metal has deposited on the plastic film.

The polymeric substrate may be pre-formed into the loop shape of the flexible conductive band. In other words, because the flexible polymeric substrate can be made as a unitary piece (i.e., without a joint), further manufacturing improvements are achieved, which is particularly advantageous for mass-produced electric motors.

Further polymeric films beyond Polyimide have also been considered by the present disclosure, including PET.

In some embodiments, the at least one flexible conductive band comprises a flexible metal substrate, optionally wherein the flexible metal substrate comprises an amorphous metal.

It may be understood that a flexible metal substrate can refer to a flexible metal foil. The flexible metal substrate may comprise stainless steel. The flexible metal substrate can further be coated on at least one side (e.g., at least one side can be coated with Titanium Nitride). This Titanium Nitride could be applied to the stainless steel substrate by any way known to the skilled person (included vacuum depositing or sputtering).

One advantage of a flexible metal substrate is that a low coefficient of friction can be achieved, which enhances the long term operation of the flexible conductive bands and limits wear.

In some embodiments, the at least one flexible conductive band is formed by welding at least one strip of the flexible metal substrate into a continuous loop of conductive material, optionally wherein the one flexible conductive band is formed by weaving in the welding operation to form a weld joint having interdigitated teeth.

It may be understood that a “strip” of a flexible substrate refers to a narrow piece of flexible substrate, which can be joined at its ends so as to form a flexible band. In one example, the metal strips can be cut via a LASER from a sheet of foil (so as to limit the edge burr on the resultant strip).

A strip may be formed into a band by welding the two ends of the strip together. The strip may be held in the correct shape (i.e., where the two ends are held adjacent to each other) via a cylindrical former (which is made of a material so as to not impact the welding process, e.g., ceramic or glass). The welding process may be performed by a LASER.

The two respective ends of the strip which are to be joined together may comprise interdigitated teeth. This can help increase the strength of the weld without increasing the weld bead thickness. Further processing can also be provided to burnish and polish the weld bead, further improving the smoothness on the band.

In some embodiments, the at least one flexible conductive band comprises a thin-film conductive coating.

Thin-film conductive coatings can further be applied to as to increase the longevity of the band, resulting in improved tribological effects for both the band and the associated tracks in the first and second portions. The conductive coatings can also be used to improve the electrical behaviour on the surface and increase the current transfer access at the interfacial region.

The material of the thin-film conductive coating may be any material which does not undergo significant work-hardening. It may also be a material that minimises heat loss (due to low electrical resistance) with a high level of adhesion. Titanium Nitride and Titanium Carbonitride may be used as coatings, for example. Alternatively, a coating of an Amorphous Metal (otherwise known as a glass metal) can be used. These materials have random atomic arrangements that do not undergo work-hardening. It is to be understood that work-hardening refers to a phenomenon that certain materials (e.g., most metals) will experience when flexed or continuously bent, which leads to crystallographic structure of the material changes and the material becoming brittle.

In some embodiments, the first portion is ring-shaped, the second portion is ring-shaped, and the second portion is configured to rotate relative to the first portion.

In some embodiments, the first ring-shaped portion has a first central axis, the first central axis running through a center of the first ring-shaped portion in a direction transverse to a plane of the first ring-shaped portion, wherein the second ring-shaped portion has a second central axis, the second central axis running through a center of the second ring-shaped portion in a direction transverse to a plane of the second ring-shaped portion, wherein the first central axis is aligned with the second central axis; and wherein the flexible conductive band is configured to revolve around the central axis to travel in the predefined path.

It is to be understood that a central axis (which runs through a center of the respective ring-shaped portion) refers to an axis around which a ring has a rotational symmetry and which passes through a center of the ring (the center being relatively equidistant to all points on an inner diameter of the ring and/or to all points on an outer diameter of the ring).

It is also to be understood that the first central axis being “aligned with” the second central axis may refer to the first axis and second axis being coincident with one another (so that the first and second ring-shaped portions share a central axis).

In some embodiments, the first ring-shaped portion and the second ring-shaped portion have different outer diameters, and are positioned concentric relative to each other, such that electrical power is configured to flow between the first conductor and the second conductor towards or away from the central axis.

It may be understood that an outer diameter refers to the distance from the center point of a ring to the external edge, which extends around an outer circumference. Likewise, an inner diameter refers to the distance from the center-point of the ring to the closer, internal edge, which extends around an inner circumference.

It is also noted that beyond having different outer diameters, the two ring portions can also have different inner diameters. In particular, one of the two ring portions can have a smaller outer diameter than the inner diameter of the other ring portion (so that the smaller ring can fit entirely within the larger ring, and remain concentric along the same axis). This allows current to flow between the first ring portion and the second ring portion in a radial direction (i.e., in a direction towards, or away from, the center point of the two rings).

In an example, the first ring-shaped portion may be smaller than the second ring-shaped portion. Alternatively, the first ring-shaped portion may be larger than the second ring-shaped portion.

It may be understood that when the flexible conductive band is configured to revolve around the central axis to travel in the predefined path, it is also moving in a rolling motion. That is, the flexible conductive band may be considered to be moving in a rolling motion in a circular fashion, around an inner circumference of the outer, larger, ring (and around the outer circumference of the inner, smaller ring). To be more specific, because the second portion is configured to rotate relative to the first portion, and because one of the ring portions is positioned concentric relative to the other (and is therefore within, or surrounding, the other ring), the flexible conductive band may be configured to move around the outermost surface of the inner ring and around the innermost surface of the outer ring.

In some embodiments, the first ring-shaped portion and second ring-shaped portion have substantially the same diameter, and are spaced apart along the central axis by a predetermined distance, such that electrical power is configured to flow between the first conductor and the second conductor along the central axis.

It may be understood that when the flexible conductive band is configured to revolve around the central axis to travel in the predefined path, it is also moving in a rolling motion. That is, the flexible conductive band may be considered to be moving in a rolling motion in a circular fashion, along the surface of a plane. To be more specific, because the second portion is configured to rotate relative to the first portion, and because the first and second portions are each ring-shaped, the flexible conductive band may be configured to move in a clockwise or counter-clockwise fashion in the area between the two adjacent ring-shaped portions.

In some embodiments, the first portion further comprises a third conductive surface, the second portion further comprises a fourth conductive surface, the electrical interface further comprises at least one secondary flexible conductive band for transmission of electrical power between the third and fourth conductive surfaces, the at least one secondary flexible conductive band is positioned between the third conductive surface and the fourth conductive surface, and the at least one secondary flexible conductive band is configured to maintain constant electrical contact between the first conductive surface and the second conductive surface when the second portion is moved relative to the first portion.

Such a configuration is of benefit when bipolar operation of an electrical instrument is required, or more generally where two separate signals need to be transmitted across the same electrical interface. In this way, a first signal (e.g., V+) can be transmitted across the flexible conductive band (i.e., a first flexible conductive band), and a second signal (e.g., V−) can be transmitted across the secondary flexible conductive band.

In some embodiments, the at least one secondary flexible conductive band comprises a plurality of secondary flexible conductive bands.

The same benefit will arise here as was provided by the plurality of flexible conductive bands.

There is also provided, according to the present invention, an electric motor comprising a stationary component, a rotatable component configured to rotate relative to the stationary component, and an electrical interface. The electrical interface can be any one of the electrical interfaces described in the embodiments above. The stationary component comprises an input terminal configured to receive the electrical power. The rotatable component comprises a plurality of conductive windings. The first portion of the electrical interface is electrically connected to the input terminal, the second portion of the electrical interface is electrically coupled to the plurality of conductive windings, and the electrical interface is configured to transmit the electrical power from the input terminal to the plurality of the conductive windings.

In some embodiments of the electric motor, the motor is a DC motor; wherein the rotatable component further comprises electronic circuitry that is connected to the plurality of conductive windings and is configured to generate motor drive signals for each of the plurality of conductive windings based on a received electrical power; and wherein the at least one flexible conductive band and/or the at least one secondary conductive band is configured to transmit the electrical power to the electronic circuitry; wherein the electronic circuitry is powered by the electrical power.

Such an electric motor is advantageous because of the low amount of friction achieved between the rotatable component (otherwise known as a rotor) and the stationary component (otherwise known as a stator). This allows for an increased power output for the motor as opposed to a similarly-sized motor having brushes.

Such a motor is also advantageous over brushed motors because of an increase in longevity for the motor. Because of the interaction between a brush of a motor and the rotor, the brushes in a typical DC motor can wear quickly, resulting in a poor electrical connection between the stator and motor (thereby rendering the motor non-operational).

There is also provided a linear electric motor comprising a stationary component, a longitudinally translatable component configured to move relative to the stationary component, and an electrical interface. The electrical interface may be any one of the electrical interfaces described in the above embodiments. The stationary component comprises an input terminal configured to receive the electrical power. The longitudinally translatable component comprises at least one conductive winding. The first portion of the electrical interface is electrically connected to the input terminal, the second portion of the electrical interface is electrically coupled to the plurality of conductive windings, and the electrical interface is configured to transmit the electrical power from the input terminal to the plurality of the conductive windings.

In some embodiments of the linear electric motor, the linear electric motor is a noncommutated linear actuator, wherein the stationary component further comprises a permanent magnet assembly, wherein the at least one flexible conductive band and/or the at least one secondary conductive band is configured to transmit the electrical power to the at least one conductive winding on the longitudinally translatable component, and wherein current flowing in the plurality of conductive windings as a result of the applied electric power is configured to interact with a permanent magnetic field generated by the permanent magnet assembly so as to generate a force for moving the longitudinally translatable component.

In a linear motor (such as a voice coil actuator), the electrical interface of the present invention replaces wired connections to a conductive winding on the longitudinally translatable component. These wires experience a high amount of stress over iterations of the linear motor being fired. Therefore, the linear electric motor of the present invention is advantageous in that component wear is reduced, and the longevity of the motor itself can be increased.

There is also provided, according to the present invention, a method of manufacturing an electrical interface. The method comprises forming the at least one flexible conductive band from either a flexible polymeric substrate or a flexible metal substrate; and positioning the at least one flexible conductive band between, and in electrical contact with, the first conductive surface of the first portion, and the second conductive surface of the second portion.

### BRIEF DESCRIPTION OF DRAWINGS

Advantageous embodiments of the present invention will now be described with reference to the accompanying drawings, wherein:

FIG. 1A is an exploded view of an exemplary electrical interface, according to the present invention.

FIG. 1B is another exploded view of the exemplary electrical interface shown in FIG. 1A.

FIG. 2 is a view of the exemplary electrical interface shown in FIGS. 1A and 1B in an assembled configuration, with a cover of the electrical interface partially removed.

FIGS. 3A and 3B are perspective views of an exemplary electric motor that includes the electrical interface shown in FIGS. 1A and 1B.

FIG. 4A is an exploded view of an alternative electrical interface, according to the present invention.

FIG. 4B is another exploded view of the alternative electrical interface shown in FIG. 4A.

FIGS. 5A and 5B are perspective illustrations of exemplary flexible conductive bands with notches, for use in an electrical interface according to the present invention.

FIG. 6 is an exploded view of an exemplary linear electric motor including an electrical interface according to the present invention.

### DESCRIPTION OF EMBODIMENTS

In the below description, the terms “first”, “second”, “third”, “fourth”, “primary”, and “secondary” are not intended to be limiting, but are rather used to distinguish different elements from each other. The proximal direction can be considered to be the input side of the electrical interface, whereas the distal direction can be considered to be the output side of the electrical interface. For the avoidance of doubt, the longitudinal axis of the electrical interface or electrical motor can be considered an axis running in a direction between the proximal end (i.e., the power input side) and the distal end of the electrical motor. For the linear motor, this longitudinal axis follows the direction of travel of the motor.

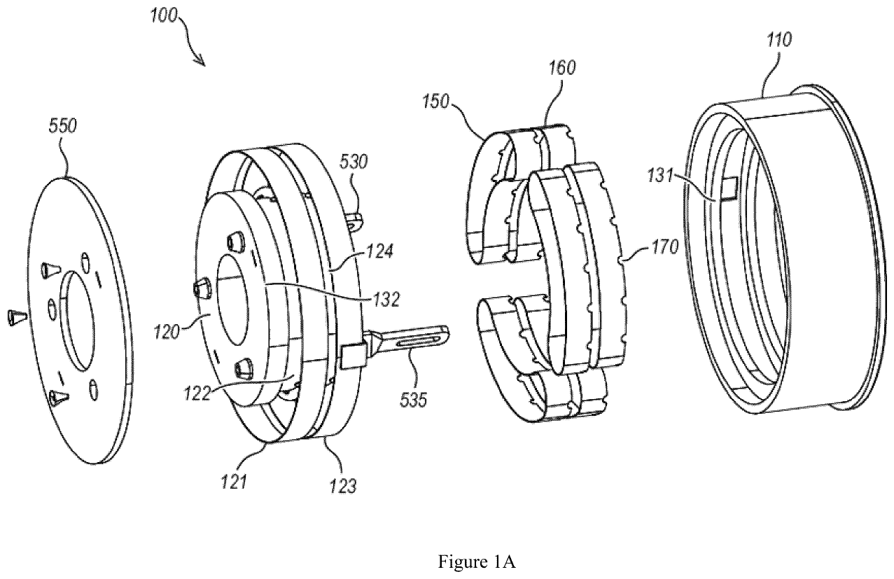

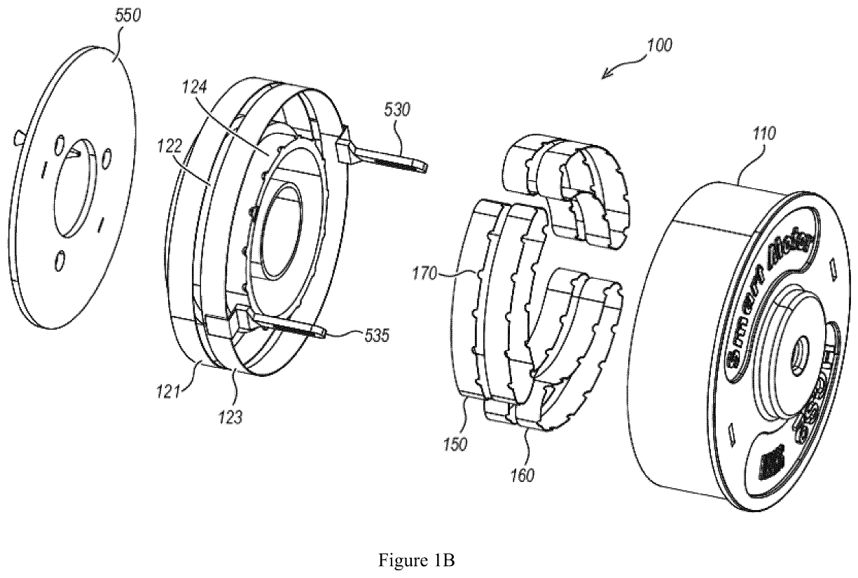

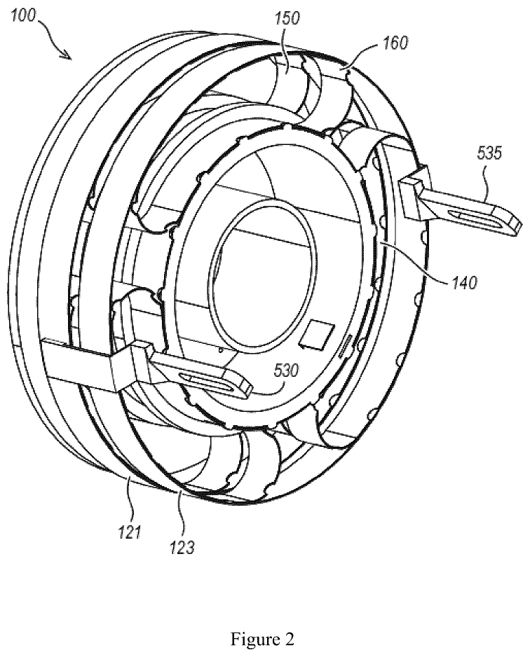

A first embodiment of an electrical interface 100 is shown in FIGS. 1A and 1B, with the components shown in an exploded view. An assembled view of the first embodiment of the electrical interface 100 is also shown in FIG. 2.

The electrical interface 100 includes a first portion 110, which may comprise at least a portion of a chassis of the electrical interface (not illustrated). A first conductive surface 121 and a third conductive surface 123 are mounted on an interior surface of the first portion 110. The electrical interface 100 also includes a second portion 120, which is configured to rotate relative to the first portion 110. A second conductive surface 122 and a fourth conductive surface 124 are mounted on an interior surface of the second portion 120.

A plurality of flexible conductive bands 150 are provided so as to transfer electrical signals from the first conductive surface 121 on the first portion 110 to the second conductive surface 122 on a second portion 120 of the electrical interface 100.

A plurality of secondary flexible conductive bands 160 are also provided so as to transfer electrical signals from the third conductive surface 123 on the first portion to the fourth conductive surface 124 on the second portion 120 of the electrical interface 100.

It may be understood that the flexible conductive bands and the secondary flexible conductive bands may be of a similar design. Throughout the specification, where structural features related to the one or more flexible conductive bands are discussed, it is to be understood that similar structural features are also present on the one or more secondary flexible conductive bands. Likewise, where structural features related to the one or more flexible conductive bands are discussed in relation to a rotating electrical interface (where electrical energy is transmitted from a stationary portion to a rotating portion), the same structural features can apply to the linear electrical interface (where electrical energy is transmitted from a stationary portion to a longitudinally-movable portion).

In this case, the first conductive surface 121 can be connected to a first input terminal so that the first conductive surface 121 can receive an electrical signal. Similarly, the third conductive surface 123 can be connected to a second input terminal so that the third conductive surface 123 can be connected to another electrical signal.

The first portion 110 comprises an electrically insulative substrate, and comprises a first insulating body 131 which serves to provide sufficient electrical isolation between the first conductive surface 121 and the third conductive surface 123. Similarly, the second portion comprises an electrically insulative substrate, and comprises a second insulating body 132 which serves to provide sufficient electrical isolation between the second conductive surface 122 and the fourth conductive surface 124.

The first insulating body 131 may define one or more tracks, which are grooves for electrically isolating a respective conductive surface positioned within the groove. The track may comprise side-walls, which not only improve the electrical isolation, but also help contain a flexible conductive band that is positioned within the track. In other words, when the flexible conductive band is moving in a predetermined path (i.e., when the second portion 120 is moving relative to the first portion 110), the flexible conductive band is constrained by the two respective conductive surfaces and by the sidewalls of the track.

Insulating body 131 and second insulating body 132 may each comprise at least one projection 140. If projections 140 are present in the electrical interface 100, either both of the insulating bodies may have projections 140, or solely one of the insulating bodies may include projections 140.

A projection 140 in the one or more of the insulating bodies 131, 132 is configured to interact with a corresponding notch 170 in the flexible conductive band 150, 160. As a result of this interaction, a flexible conductive band 150, 160 can be more easily pulled into a rolling motion when the first portion 110 moves relative to the second portion 120. This can result in an improved electrical connection between the first portion 110 and the second portion 120, and can also reduce the amount of friction present between the flexible conductive band and each of the first and second portions 110, 120.

Nevertheless, it is noted that projections 140 are not essential for providing the rolling motion, which would occur regardless of whether the projections are present to engage with the respective flexible conductive band.

The projections 140 which help provide a spacing between adjacent flexible conductive bands). However, as noted above, notches and projections 170, 140 may be omitted. This is one option where there is a single flexible conductive band 150 connecting a first conductive surface 121 to a second conductive surface 122. In this embodiment, when a single flexible conductive band is used for transmitting electrical power, there is no risk of two bands coming into contact with each other, and therefore the omission of the notches and projections results in a more easily manufacturable device.

In operation, a first voltage (V+) can be applied to the first input terminal 530, and a second voltage (V−) can be applied to the second input terminal 535. As a result, the first conductive surface 121 will be connected to the first voltage, whilst the third conductive surface 123 will be connected to the second voltage.

The first and second voltages can each be either DC or AC voltages. Whilst the two signals can be galvanically isolated from each other (which may be the case if two distinct monopolar signals are being transmitted across the electrical interface 100), it is also considered that the second voltage provides a return path for the first voltage (i.e., the first input voltage and the second input voltage are each part of a bipolar signal). In other words, the second voltage may be a reference point (e.g., electrical ground, or any other voltage reference point), so that current will flow from the first input terminal 530 to the second input terminal 535 (or vice versa). Such is the case when the electrical interface 100 is implemented in a motor, where current flows into the motor via the first input terminal 530 and leaves the motor via the second input terminal 535.

In this example, the first conductive surface 121 and third conductive surface 123 are ring shaped (or annular shaped). The first and third conductive surfaces 121, 123 have similar dimensions, and are mounted onto the stationary first portion 110. The second conductive surface 122 and fourth conductive surface 124 are similarly ring shaped. The second and fourth conductive surfaces 122, 124 have similar dimensions to one another, and are each mounted onto the second portion 120, which is suitable for rotating.

The diameters of the second and fourth conductive surfaces 122, 124 can be smaller than the respective diameters of the first and third conductive surfaces 121, 123. Likewise, the second portion 120 can be of a smaller dimension than that of the first portion 110. As a result, the second portion 120 can be configured to fit within the larger, first portion 110. When this is the case, the first conductive surface 121 can be aligned with the second conductive surface 122 in a direction along a longitudinal axis of the electrical interface 100, and the at least one flexible conductive band 150 can be configured to transmit electrical signals from the first conductive surface 121 in a radial direction. The same alignment is true of the third and fourth conductive surfaces 123, 124 and the corresponding at least one secondary flexible conductive band 160.

As a result of the flexible conductive bands 150, 160 in the electrical interface 100, the first conductive surface 121 remains in contact with the second conductive surface 122, even when the second portion is rotating relative to the first portion 110. Similarly, the third conductive surface 123 remains in contact with the fourth conductive surface 124 whilst the second portion 120 is rotating relative to the first portion 110.

Whilst the second portion 120 is rotating, both the plurality of flexible conductive bands 150 and the plurality of second flexible conductive bands 160 are configured to move in a rolling fashion around the circumference of the first conductive surface 121 and third conductive surface 123, respectively, of the first portion 110. Such a rolling motion provides for a constant electrical connection between the stationary, first portion 110 and the rotating, second portion 120, with a low amount of friction.

The electrical interface 100 of the present invention may therefore provide a means for transmitting power and electrical signals from a stationary component 510 to a rotating component 520. The electrical interface 100 of the present invention may therefore be considered an improved slip-ring assembly, which provides a high current capacity, high resilience to wear, and low friction, all of which make the electrical interface 100 particularly advantageous for delivering electrical signals to an electrical motor assembly.

It is of course to be understood that the electrical interface 100 of the present invention is not solely limited to motor designs, and it could be used as a replacement for a typical brushed slip-ring assembly, wherever electrical power needs to be transferred from a stationary to a rotating structure.

In the electrical interface 100 shown in FIGS. 1A and 1B, the electrical signals present on the second and fourth conductive surfaces 122, 124 can be delivered to other electrical hardware which can be mounted onto (or otherwise coupleable to) the second portion. In some embodiments, this electrical hardware can be electronic circuitry 550 of a motor.

In one example, conductive pathways exist to communicate the signal on the second conductive surface 122 and the signal of the fourth conductive surface 124 to the electrical hardware, which is connected to the second portion 120 of the electrical interface 100. The electrical hardware can be either mounted onto the second portion 120, or indirectly coupled to the second portion 120. Any suitable types of conductive pathways would be possible for such an electrical connection to the electrical hardware (e.g., wires, metal vias, traces and/or via holes on a printed circuit board).

These connections may connect to each of the second and fourth conductive surfaces 122, 124 on the underside of the second and fourth conductive surfaces 122, 124, respectively (i.e., the opposite side of the conductive surfaces as the side where the flexible conductive bands are in contact), so as to not interfere with the flexible conductive bands 150, 160.

In this way, the first input voltage (V+) and the second input voltage (V−) delivered to the first portion 110 of the electrical interface 100 can be transmitted to the rotating second portion 120, and used to power the electronic circuitry 550.

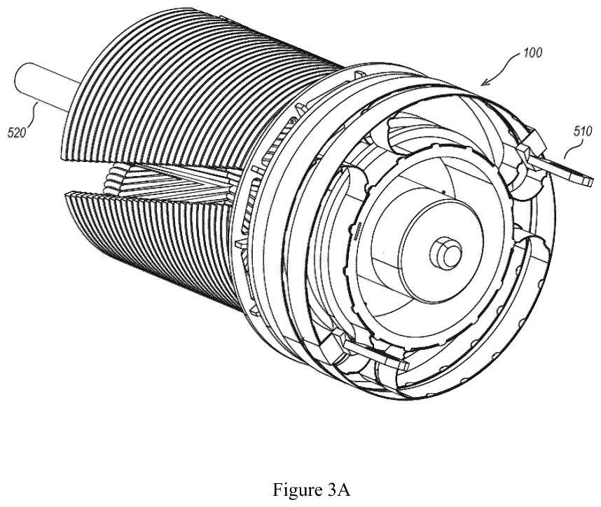

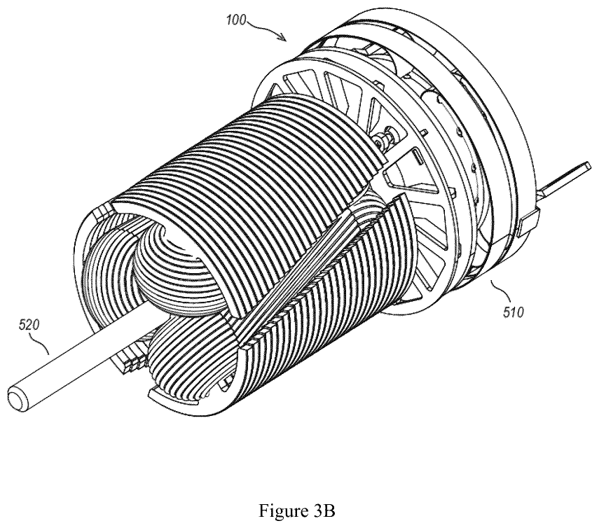

FIGS. 3A and 3B illustrate an embodiment of an electric motor according to the present invention. The electric motor includes an electrical interface 100 having a similar structure to the electrical interface 100 described above, and the electrical interface 100 will therefore not be discussed in further detail.

In this embodiment, the electric motor comprises electronic circuitry 550 and a plurality of conductive windings. This electronic circuitry 550 may be mounted directly onto the second portion 120 of the electrical interface 100. The output of the electronic circuitry may be connected to the plurality of conductive windings, and the input of the electronic circuitry 550 may be connected to the first voltage (V+) and the second voltage (V−).

Conductive pathways can be present at the output of the electrical interface 100 to communicate the signal on the second conductive surface 122 and the signal of the fourth conductive surface 124 of the electric interface to electronic circuitry 550, which is connected to the second portion 120 of the electrical interface 100. Any suitable types of conductive pathways would be possible for such a connection (e.g., wires, metal vias, traces and/or via holes on a printed circuit board). These connections may connect to the underside of the second and fourth conductive surfaces (i.e., the opposite side of the conductive surfaces as the side where the flexible conductive bands are in contact), so as to not interfere with the flexible conductive bands.

Such an electric motor also comprises a plurality of permanent magnets (not shown). The interaction between current flowing in the plurality of conductive windings and the magnetic fields generated by the plurality of permanent magnets can produce a torque sufficient to rotate the motor when current is applied to the plurality of conductive windings.

The electronic circuitry 550 may be electronic drive circuitry which is powered by the first and second voltages (V+, V−), and configured to generate and deliver drive signals to the plurality of conductive windings so as to operate the motor.

In some embodiments, the first and second voltages that are input to the electrical interface 100 may be DC signals. In other words, the electric motor may be a DC motor (as a DC signal is input to the motor), and the electronic circuitry 550 of the motor configured to generate the appropriate drive signals within the motor so as to operate the motor.

In some embodiments, the plurality of conductive windings comprises armature coils of a three-phase motor. In such an application, the electronic drive circuitry is configured to generate three-phase drive signals for the three armature coils of the three-phase motor.

However, the application is not limited as such, and any number of phases can implemented. When multiple phases (2 or more) are present in the motor, the number of armature coils will match the number of phases present in a drive signal generated by the electronic drive circuity. For example, if there are four armature phase windings present in the motor, then a four-phase signal can be generated by the electronic drive circuitry so as to deliver the appropriate signals to the appropriate armature coils.

In other words, the electronic drive circuitry is configured to generate signals in each of the plurality windings (which form part of the rotor), so that the current flow is appropriate to interact with the permanent magnetic fields present at the rotor, thus generating a torque.

The electronic drive circuitry may be configured to receive one or more signals from a sensor assembly (not shown) present within the motor. For example, the sensor assembly may comprise a position sensor configured to generate relative or absolute position signals, which can be utilized by the electronic drive circuitry to generate the drive signals to the respective windings at an appropriate time.

The more armature phase windings present on the electric motor, the less detent cogging (otherwise known as armature cogging) and the smoother overall motor operation will arise. This is especially useful and desired in applications where vibrations that can be imparted by a motor to an attached apparatus need to be minimized (e.g., in a servo motor, which has a rigid mounting of said motor to the structure of an apparatus).

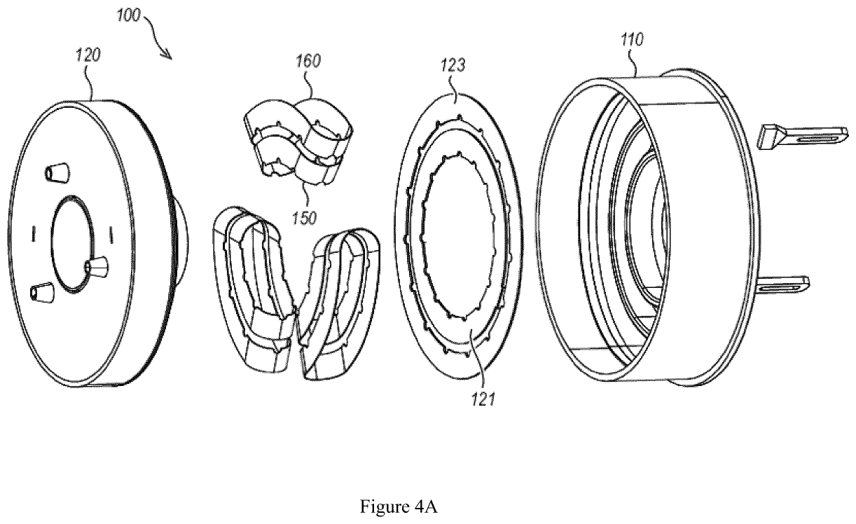

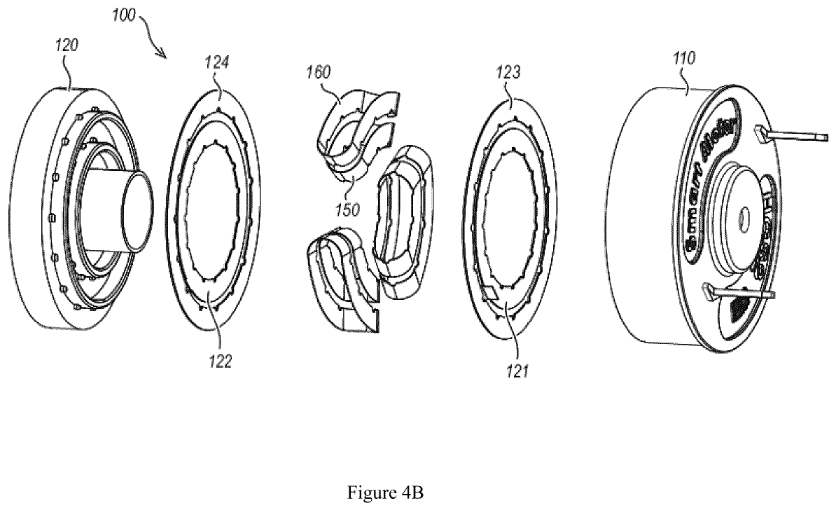

An alternative embodiment of the invention is illustrated in FIGS. 4A and 4B.

This embodiment operates much in the same way as described above, with the following distinctions. In the same way as above, an electrical signal present on a first conductive surface 121 is configured to be transmitted to a second conductive surface 122 via at least one flexible conductive band. Likewise, an electrical signal present on a third conductive surface 123 is configured to be transmitted to a fourth conductive surface 124 via at least one secondary flexible conductive band 160. Similar to the above embodiment, all of the conductive surfaces 121, 122, 123, 124 are ring shaped, albeit with different dimensions so as to allow the appropriate transmission of electrical signals.

However, in this alternative embodiment, the second and fourth conductive surfaces 122, 124 are mounted on a proximal face of the second portion 120. The at least one flexible conductive band 150 and at least one secondary conductive band 160 are configured to connect the second and fourth conductive surfaces 122, 124 to first and third conductive surfaces 121, 123 mounted on the first portion 110, so as to transfer current in a direction parallel to the longitudinal axis of the electrical interface 100. That is, the first and third conductive surfaces 121, 123 are positioned proximally to the respective second and fourth conductive surfaces 122, 124. In other words, the first conductive surface 121 is configured to face the second conductive surface 122 in a direction defined by the longitudinal axis. The same is true of the third and fourth conductive surfaces 123, 124.

In this embodiment, the first conductive surface 121 may have dimensions corresponding to the second conductive surface 122. The third conductive surface 123 may have dimensions corresponding to the fourth conductive surface. It may be understood that “corresponding to” refers to an arrangement where the dimensions are identical (i.e., the first conductive surface has the same shape and size of the second conductive surface). However, the first and second conductive surfaces 121, 122 may have dimensions that are different from the third and fourth conductive surfaces 123, 124.

In other words, the electrical signal present on the first and second conductive surfaces 121, 122 (e.g., V+) can be present on an interior portion of the electrical interface 100, whilst the electrical signal present on the third and fourth conductive surfaces 123, 124 (e.g., V−) can be present on an exterior portion of the electrical interface 100.

As a result of the flexible conductive bands 150, 160 in the electrical interface 100, the first conductive surface 121 remains in contact with the second conductive surface 122, even when the second portion 120 is rotating relative to the first portion 110. Similarly, the third conductive surface 123 remains in contact with the fourth conductive surface 124 whilst the second portion 120 is rotating relative to the first portion 110.

Whilst the second portion 120 is rotating, both the plurality of flexible conductive bands 150 and the plurality of secondary flexible conductive bands 160 are configured to move in a rolling fashion around the circumference of the first conductive surface 121 of the first portion 110. In order for such a rolling to occur, the flexible conductive bands 150, 160 are also configured to turn—in other words, a point along the outer edge of a flexible conductive band in this embodiment will travel a further distance than a corresponding point along the inner edge of the band. Such a rolling motion provides for a constant electrical connection between the stationary, first portion 110 and the rotating, second portion 120, with a low amount of friction.

The notches 170, projections 140, electrical insulating bodies 131, 132, and tracks all provide similar functions as those described above, and will not be described in further detail. It is to be understood that the notches, projections, and electrical insulating bodies may all be present in this embodiment.

In the electrical interface 100 shown in FIGS. 4A and 4B, the electrical signals present on the second and fourth conductive surfaces 122, 124 of the second portion 120 can be delivered to other electrical hardware which can be mounted onto (or otherwise coupleable to) the second portion. In some embodiments, this electrical hardware can be electronic circuitry 550 of a motor.

In one example, conductive pathways exist to communicate the signal on the second conductive surface 122 and the signal of the fourth conductive surface 124 to the electrical hardware, which is connected to the second portion of the electrical interface 100. The electrical hardware can be either mounted onto the second portion, or indirectly coupled to the second portion. Any suitable types of conductive pathways would be possible for such an electrical connection to the electrical hardware (e.g., wires, metal vias, traces and/or via holes on a printed circuit board).

These connections may connect to each of the second and fourth conductive surfaces 122, 124 on the underside of the second and fourth conductive surfaces, respectively (i.e., the opposite side of the conductive surfaces as the side where the flexible conductive bands 150, 160 are in contact), so as to not interfere with the flexible conductive bands.

In this way, the first input voltage (V+) and the second input voltage (V−) delivered to the first portion 110 of the electrical interface 100 can be transmitted to the rotating second portion 120, and used to power electrical hardware (such as electronic circuitry 550 of a motor).

It is to be understood that whilst two electrical interface 100s are provided in the above illustrated embodiments, the application is not limited thereto. There could be a single electrical interface 100 (i.e., a first and second conductive surface 121, 122), or further (e.g., 3 or more) electrical interfaces 100 could also be provided within the same device.

According to an embodiment, there is also provided an electric motor implementing the alternative electric interface. The electronic drive circuitry 550 of the electric motor, and the further hardware of the motor (i.e., the plurality of conductive windings, the permanent magnet assembly, etc.) are identical to the componentry described with reference to FIGS. 3A and 3B, and will not be reiterated here. It is to be understood that there is provided an electric motor which is identical to the motor described in relation to FIGS. 3A and 3B, but with a distinct electrical interface 100 for transmitting electrical signals from the first portion 110 to the second portion 120.

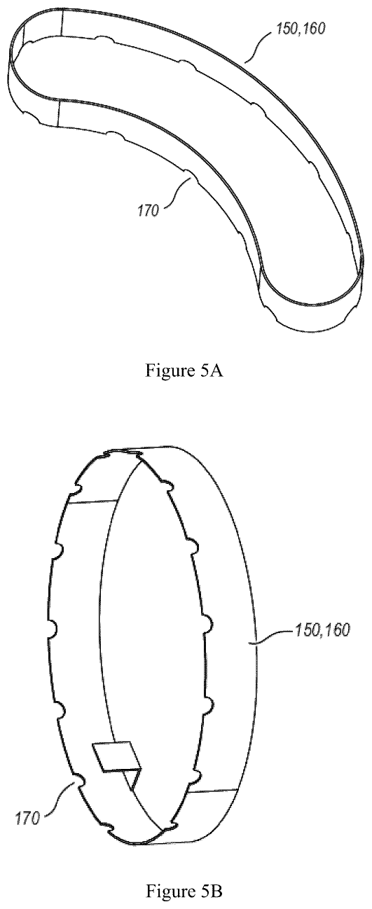

FIGS. 5A and 5B are illustrations of exemplary flexible conductive bands 150, 160 for use in an embodiment of the present invention.

As shown in these figures, the flexible conductive band 150, 160 may comprise a plurality of notches 170, which can be dispersed around at least one of the edges of the flexible conductive band 150, 160. In some instances, there can be a first plurality of notches 170 along a first edge of the flexible conductive band 150, 160, and a second plurality of notches along a second edge of the flexible conductive band 150, 160.

These flexible conductive bands 150, 160 may be flexible metal foils such as stainless steel that have been coated on at least one side. In some examples, this coating can be Titanium Nitride (which for example can be applied by way of vacuum deposition or sputtering). This coating results in a very low coefficient of friction which further enhances the long term operation on the bands and tracks.

Alternatively, high performance polymeric film materials (such as KAPTON™ which is a type of polyimide plastic film, and PET, or Polyethylene Terephthalate) can be used instead of metal foils. Such a polymeric film can have excellent flexibility and can withstand many flexing and bending cycles without failure. This polyimide film can also be coated with a multitude of highly electrically conductive coatings and finishes like graphene. Then, further coatings can be applied via electroless-plating or electroplating by ion deposition in solution. This allows the application of metals in solution like copper chloride, copper sulphate, nickel, palladium, ruthenium or any other appropriate metal.

The process of adding multiple platings and coating onto flexible plastic substrates can be a very fit for small motors that are mass-produced and can further reduce the dependency of costly metals that are in use today for such motors.

A coating can also be applied to a polymeric film with a liquid based Nano-Silver ink. Such an ink can be deposited by way of ink-jet delivery, or by silk-screen printing or rotogravure printing processes that involve a photo-curable nano-silver oxide ink that instantly changes to a metallic state (via surface reduction) when it comes into contact with a polymer, such as PET (Polyethylene Terephthalate). This conversion from the oxide state to the metallic state (moisture assisted electron conversion) can be used to facilitate a further deposition of an electroless copper (on top of the cured Nano Silver coating) which in turn leads to a very low cost conductive flexible band or disc for use present invention.

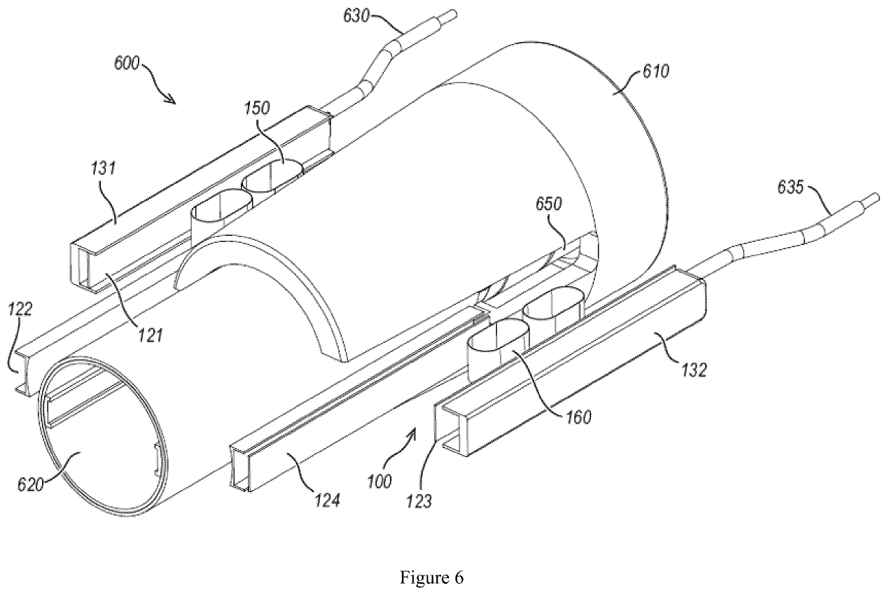

FIG. 6 illustrates an embodiment of a linear electric motor 600 implementing an electric interface 100 according to one embodiment of the invention. As illustrated in FIG. 6, the motor may be a type of voice coil actuator (i.e., a non-commutated linear actuator). In this embodiment, the connections between the first and second conductive surfaces 121, 122 (and between the third and fourth conductive surfaces 123, 124) is made via the at least one flexible conductive band 150 and the at least one secondary flexible conductive band 160. In this illustration, there are two flexible conductive bands 150 and two secondary flexible conductive bands 160, but the application is not limited thereto. That is, there could be any number of flexible conductive bands (and secondary flexible conductive bands), including 1 or any integer number above 1.

The transmission of electrical power between the first and second conductive surfaces 121, 122 (and between the third and fourth conductive surfaces 123, 124) follows the same principles of the rotating electrical interface 100 described above (where one portion is rotating relative to the other portion). Instead, in this embodiment, the second portion 120 is configured to move in a linear fashion relative the first portion 110 in the longitudinal direction, and the respective conductive portions correspondingly extend in the longitudinal direction. The movement of the flexible conductive bands 150, 160 (i.e. a rolling motion within respective tracks of insulating bodies 131, 132, so as to maintain constant electrical contact between two conductive surfaces) follows the same principles as those discussed in relation to the rotary embodiment. The second portion may be fixedly mounted onto the longitudinally translatable component 620.

In this linear motor 600, a bipolar electrical signal is delivered to the input terminals of the motor 630, 635 on the stationary component 610, so as to provide electrical power. This signal can be either an AC or a DC waveform, having a first input (V+) and a second input (V−).

The first input is connected to the first conductive surface 121, which is in constant electrical connection with the second conductive surface 122 (which is mounted on the longitudinally translatable component 620 via the at least one secondary flexible conductive bands. Likewise, the second input is connected to the third conductive surface 123, which is in constant electrical connection with the fourth conductive surface (which is mounted on the longitudinally translatable component 620 via the at least one secondary flexible conductive bands. In this way, the bipolar electrical signal can be delivered to the longitudinally translatable component without the need for high-wear componentry, such as brushes.

There is also provided at least one conductive winding (not shown) on the longitudinally translatable component 620, which connects the second conductive surface 122 to the fourth conductive surface. As a result of this connection, electrical current will flow from the first input 630 to the second input 635. More specifically, when a power supply (not shown) is attached to the input terminal of the motor, electrical current will flow from the input terminal to the first conductive surface 121, to the at least one flexible conductive band, to the second conductive surface 122, to the at least one conductive winding, to the fourth conductive surface 124, to the at least one secondary flexible conductive band 160, and to the third conductive surface 123 to return to the input terminal.

As a result of the above electrical connections, current will flow through the at least one conductive winding present on the longitudinally translatable component. This current will interact with the permanent magnet assembly 650 of the linear electric motor, which will generate a force so as to move the longitudinally-translatable component 620 of the linear motor in either a distal or proximal fashion relative to the stationary component 610 (depending on the polarity of the signal input to the input terminal).

The preceding description has been presented with reference to presently disclosed embodiments of the invention. Workers skilled in the art and technology to which this invention pertains will appreciate that alterations and changes in the described structure may be practiced without meaningfully departing from the principal, spirit and scope of this invention. As understood by one of ordinary skill in the art, the drawings are not necessarily to scale and any feature or combinations of features described in any one embodiment may be incorporated into any other embodiments or combined with any other feature(s) of other embodiments, as desired or needed. Accordingly, the foregoing description should not be read as pertaining only to the precise structures described and illustrated in the accompanying drawings, but rather should be read consistent with and as support to the following claims which are to have their fullest and fair scope.

1. An electrical interface comprising a first portion with a first conductive surface, a second portion with a second conductive surface, and at least one flexible conductive band configured to transmit electrical power between the first and second conductive surfaces,
wherein the second portion is configured to move relative to the first portion,
wherein the at least one flexible conductive band is positioned between the first conductive surface and the second conductive surface,
wherein the at least one flexible conductive band is configured to maintain constant electrical contact between the first conductive surface and the second conductive surface when the second portion is moved relative to the first portion.

2. The electrical interface of claim 1, wherein the at least one flexible conductive band is configured to interact mechanically with the first portion at a first contact area and interact mechanically with the second portion at a second contact area, such that when the second portion is moved relative to the first portion the flexible conductive band is configured to travel in a predefined path along the first conductive surface.

3. The electrical interface of claim 2, wherein, to travel in the predefined path, the at least one flexible conductive band is configured to move in a rolling motion.

4. The electrical interface of any preceding claim, wherein:
the first portion comprises a first insulating body,
the second portion comprises a second insulating body,
the first conductive surface is mounted on the first insulating body, and
the second conductive surface is mounted on the second insulating body.

5. The electrical interface of claim 4, wherein the first conductive surface is positioned within a track in the first insulating body, and wherein the second conductive surface is positioned within a track in the second insulating body.

6. The electrical interface of claim 4 or 5, when dependent on claim 2,
wherein the first insulating body, the second insulating body, or both of the first and second insulating bodies comprise at least one projection, and
wherein the at least one conductive band comprises at least one notch configured to interact with the at least one projection as the flexible conductive band travels along the predefined path.

7. The electrical interface of claim 6,
wherein the first insulating body, the second insulating body, or both of the first and second insulating bodies comprise a plurality of projections, and
wherein the at least one conductive band comprises a plurality of notches configured to interact with the plurality of projections as the at least one flexible conductive band travels along the predefined path.

8. The electrical interface of any preceding claim, wherein the at least one flexible conductive band comprises a plurality of flexible conductive bands.

9. The electrical interface of any preceding claim, wherein the at least one flexible conductive band comprises a flexible polymeric substrate with a conductive coating, optionally wherein the flexible polymeric substrate comprises polyimide.

10. The electrical interface of any one of claims 1 to 8, wherein the at least one flexible conductive band comprises a flexible metal substrate, optionally wherein the flexible metal substrate comprises an amorphous metal.

11. The electrical interface of claim 10, wherein the at least one flexible conductive band is formed by welding at least one strip of the flexible metal substrate into a continuous loop of conductive material, optionally wherein the one flexible conductive band is formed by weaving in the welding operation to form a weld joint having interdigitated teeth.

12. The electrical interface of any preceding claim, wherein the at least one flexible conductive band comprises a thin-film conductive coating.

13. The electrical interface of any preceding claim, wherein:
the first portion is ring-shaped,
the second portion is ring-shaped, and
the second portion is configured to rotate relative to the first portion.

14. The electrical interface of claim 13,
wherein the first ring-shaped portion has a first central axis, the first central axis running through a center of the first ring-shaped portion in a direction transverse to a plane of the first ring-shaped portion,
wherein the second ring-shaped portion has a second central axis, the second central axis running through a center of the second ring-shaped portion in a direction transverse to a plane of the second ring-shaped portion,
wherein the first central axis is aligned with the second central axis; and
wherein the flexible conductive band is configured to revolve around the central axis to travel in the predefined path.

15. The electrical interface of claim 14, wherein the first ring-shaped portion and the second ring-shaped portion have different outer diameters, and are positioned concentric relative to each other, such that electrical power is configured to flow between the first conductor and the second conductor towards or away from the central axis.

16. The electrical interface of claim 14, wherein the first ring-shaped portion and second ring-shaped portion have substantially the same diameter, and are spaced apart along the central axis by a predetermined distance, such that electrical power is configured to flow between the first conductor and the second conductor along the central axis.

17. The electrical interface of any preceding claim, wherein:
the first portion further comprises a third conductive surface,
the second portion further comprises a fourth conductive surface,
the electrical interface further comprises at least one secondary flexible conductive band for transmission of electrical power between the third and fourth conductive surfaces,
the at least one secondary flexible conductive band is positioned between the third conductive surface and the fourth conductive surface, and
the at least one secondary flexible conductive band is configured to maintain constant electrical contact between the third conductive surface and the fourth conductive surface when the second portion is moved relative to the first portion.

18. The electrical interface of claim 17, wherein the at least one secondary flexible conductive band comprises a plurality of secondary flexible conductive bands.

19. An electric motor comprising a stationary component, a rotatable component configured to rotate relative to the stationary component, and the electrical interface of any preceding claim,
wherein the stationary component comprises:
an input terminal configured to receive the electrical power; and
wherein the rotatable component comprises:
a plurality of conductive windings; and
wherein the first portion of the electrical interface is electrically connected to the input terminal,
wherein the second portion of the electrical interface is electrically coupled to the plurality of conductive windings, and
wherein the electrical interface is configured to transmit the electrical power from the input terminal to the plurality of the conductive windings.

20. The electric motor of claim 19, when dependent on claim 17,
wherein the motor is a DC motor;
wherein the rotatable component further comprises electronic circuitry that is connected to the plurality of conductive windings and is configured to generate motor drive signals for each of the plurality of conductive windings based on a received electrical power; and
wherein the at least one flexible conductive band and/or the at least one secondary conductive band is configured to transmit the electrical power to the electronic circuitry;
wherein the electronic circuitry is powered by the electrical power.

21. A linear electric motor comprising a stationary component, a longitudinally translatable component configured to move relative to the stationary component, and the electrical interface of any one of claims 1 to 12,
wherein the stationary component comprises an input terminal configured to receive the electrical power;
wherein the longitudinally translatable component comprises at least one conductive winding;
wherein the first portion of the electrical interface is electrically connected to the input terminal,
wherein the second portion of the electrical interface is electrically coupled to the at least one conductive winding, and
wherein the electrical interface is configured to transmit the electrical power from the input terminal to the plurality of the conductive windings.

22. The linear electric motor of claim 21, when dependent on claim 17,
wherein the linear electric motor is a non-commutated linear actuator,
wherein the stationary component further comprises a permanent magnet assembly,
wherein the at least one flexible conductive band and/or the at least one secondary conductive band is configured to transmit the electrical power to the at least one conductive winding on the longitudinally translatable component, and
wherein current flowing in the plurality of conductive windings as a result of the applied electric power is configured to interact with a permanent magnetic field generated by the permanent magnet assembly so as to generate a force for moving the longitudinally translatable component.

23. A method of manufacturing an electrical interface according to any one of claims 1 to 18, the method comprising:
forming the at least one flexible conductive band from either a flexible polymeric substrate or a flexible metal substrate; and
positioning the at least one flexible conductive band between, and in electrical contact with, the first conductive surface of the first portion, and the second conductive surface of the second portion.
